(19) United States
(12) Patent Application Publication
(10) Pub. No.: US 2010/0100729 A1
(43) Pub. Date: Apr. 22, 2010

(54) Distribution medium for professional photography

(76) Inventors: Christopher Jensen Read, San Diego, CA (US); Robert L. Hardacker, Escondido, CA (US)

Correspondence Address: MILLER PATENT SERVICES, 2500 DOCKERY LANE, RALEIGH, NC, 27606, US

(21) Appl. No.: 12/288,494

(22) Filed: Oct. 21, 2008

(51) Int. Cl. G06F 21/24; H04L 9/28

(52) U.S. Cl. 713/156; 713/150

(57) ABSTRACT

The display of very high definition still images on a high definition television is achieved through the decryption of received images within a DRM capable decryption device embedded within a high definition TV. The decryption device stores a pre-set decryption key, decrypts the incoming high definition still image content, and applies pre-set licensing parameters against the decrypted content. If the license for the encrypted content is determined to be valid the very high definition still images are displayed on the TV, otherwise the TV will display a lack of authorization message if the licensing is determined to be not valid. The embedded DRM decryption device is capable of determining and enforcing a number of licensure conditions for any and all received encrypted imagery. This abstract is not to be considered limiting, since other embodiments may deviate from the features described in this abstract.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Professional photographers like to obtain payment for each copy of a print they sell. In the digital age photographers don't like to allow digital copies of their photos because the photos can be duplicated infinitely. The display of very high resolution digital imagery can command a premium in the marketplace.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a view of the transmission of content consistent with certain embodiments of the present invention.

FIG. 2 is a view of the hardware components of the system consistent with certain embodiments of the present invention.

FIG. 3 is a diagram of the processing of content from a provider consistent with certain embodiments of the present invention.

FIG. 4 is a diagram of the receipt and display of ultra-HD content consistent with certain embodinents of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment”, “an example”, “an implementation” or similar terms means that a particular feature, structure, or characteristic described in connection with the embodiment, example or implementation is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments, examples and implementations without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The tern “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

Professional photographers do not like to provide digital images of their best work due to the ease with which digital images may be copied and distributed far beyond the photographer's control, regardless of the violation of copyright. New displays that provide for the display of digital images that are equivalent to a 24 Megapixel camera image may be susceptible to such image piracy. To minimize such unauthorized copying a new display may be provided with an imbedded DRM mechanism that will allow distribution on TV displays that are both capable of displaying such high quality images and protecting the photography copyright in such images at the same time.

In an exemplary embodiment the images to be displayed are very high definition still images that are of sufficient quality to be considered artistic or museum display quality. These images may be displayed upon a television display that is capable of very high resolution, such as a 4 k×2 k pixel display. The images are capable of being displayed, but, in the exemplary embodiment, are restricted from being printed.

In the exemplary embodiment, a Digital Rights Management (DRM) module is provided within the television display to manage copy rights and display protection for the high definition still images. A photographer or other content provider may set the license restrictions for usage of the high definition still images. In an exemplary embodiment, the use may be for a one time display of the high definition still image, time-limited to a finite span. The use may be for permanent display on a single high definition television set, or may provide for a group of subsidiary licenses that allow for display on multiple television displays properly enabled with the DRM licensure module. In another embodiment, the license may provide for the high definition still images to be moved from one display to another, or loaned out to another individual for a set period of time for display on their own high definition television display, again, suitably enabled.

In an alternative embodiment, the DRM may issue a temporary license that is re-granted regularly. In this way the copy of the photo could be moved from one TV to a newer TV at some time in the future, by changing the device to which the photo is licensed. In this manner, the photographer's rights and the user's rights to the high definition still images are protected. The photos might work on both devices temporarily, but only as long as the temporary license is valid. Additionally, a license may also be “checked-out” by the DRM module such that the high resolution still image may be placed into a portable device for display on another high resolution television device suitably enabled with a DRM licensure module. The checked-out license may expire after a suitable time period or the image could be checked back in to the originating television display device, whereupon the high resolution still image will be displayed upon the originating television.

In an additional embodiment, the DRM licensing could provide for limited hardcopy printing of each high resolution still image. The fee structure for printing may be established prior to dissemination of the still images and a license for printing purchased separately. The printing license will be administered by the DRM license module within the TV device and permit printing only as provided by the license terms purchased by a user.

In another exemplary embodiment, sample images may be distributed that are freely moveable from one TV display to another. These sample images may be offered by image providers as free advertising for the quality of the still images. The license offered would be an open license that the DRM license module would recognize and authorize display of such images with no restrictions. In this exemplary embodiment images could also be offered freely for a limited time and later purchased. For example, images of general interest, such as Yosemite Valley, or movie posters, that could be downloaded on a trial basis, then purchased if desired. Thumbnails or lower resolution images could also be viewed for selection of desired purchases before the short term license trial download of the full resolution image.

In a further exemplary embodiment, temporary licenses for use of high resolutions images may be available on a very short term basis such as renting an image for display during a function such as a party, event, speaking engagement, or other time limited event. In the exemplary embodiment, the renter of the image would receive use of the image by “checking out” the picture to a portable device for transport to another location at the beginning of the rental time period, whereupon the portable device would be set up for display of the image for all of the attendees to share. The checked-out license could expire or be checked back in at the end of the rental period. The image would cease to be displayed at the termination of the rental period when the license expires.

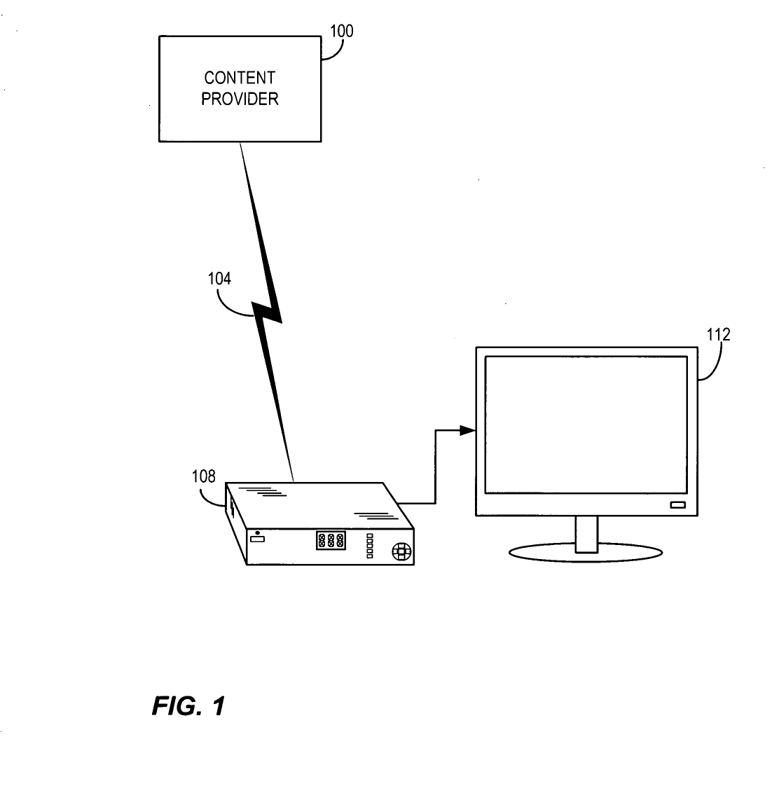

Turning now to FIG. 1, in an exemplary embodiment the system will provide for the dissemination of very high resolution still images from a content provider 100. The very high resolution still images may have resolutions, for example, greater than or equal to 3500 by 1800 pixels. The still images may be prepared for dissemination by encrypting the still image files with one or more encryption keys that have been previously distributed to one or more TV display devices. The encryption is one that will be understood by at least one DRM decryption and license module. In this exemplary embodiment, a user may have contracted for the purchase of a very high resolution still image and the encryption associated with that user may be used to encrypt the still image, or the encryption may be a general encryption that is understood by all DRM decryption and licensing modules in the field. The still images are then transmitted across a wired or wireless communication channel 104 to a user device such as a Set-top Box 108. The use of a Set-top Box is only one example of a television receiver device and not intended to be limiting, there are other mechanisms for the transmission of such still images to be captured for presentation to a DRM decryption and license module, such as distribution to a cable box or directly to a TV device. The encrypted very high resolution still images are then sent to the TV display device 112 for decryption and display.

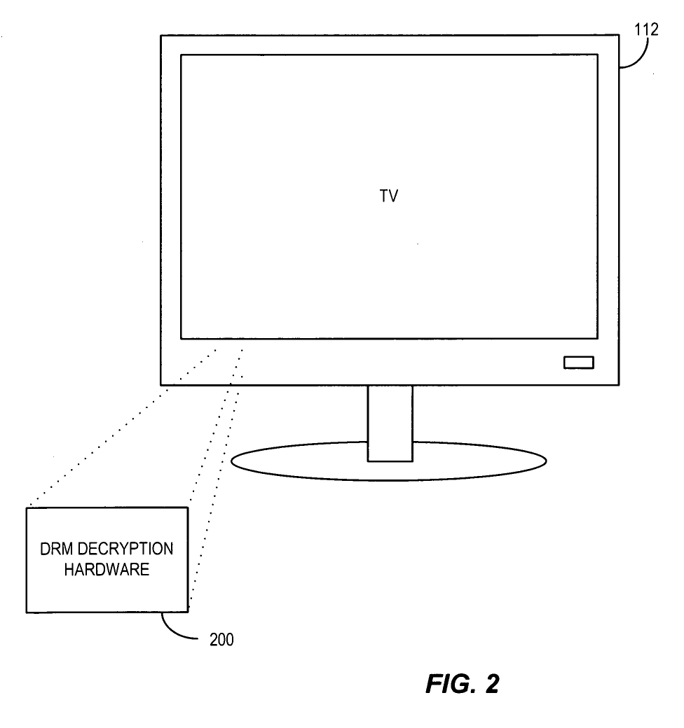

Turning now to FIG. 2, in an exemplary implementation, a DRM decryption and licensing module 200 is installed within a TV display device 112. In this exemplary embodiment, the DRM decryption and licensing module is embodied within a separate hardware device that contains a processor operative to perform decryption of received encrypted still image files and to evaluate the license transmitted with the received still images to determine the license rights that the user has received with the associated still images. Some license rights may include the ability to freely display the still image, to display the still image for a limited period of time, to share or relocate the still image for a limited number of actions or a limited period of time, to permit limited hardcopies of the received still image, or a purchased ownership interest in the still image or any combination of the above. These license rights are exemplary and do not necessarily express all possible license rights that may be available to a user by the DRM decryption and licensing module.

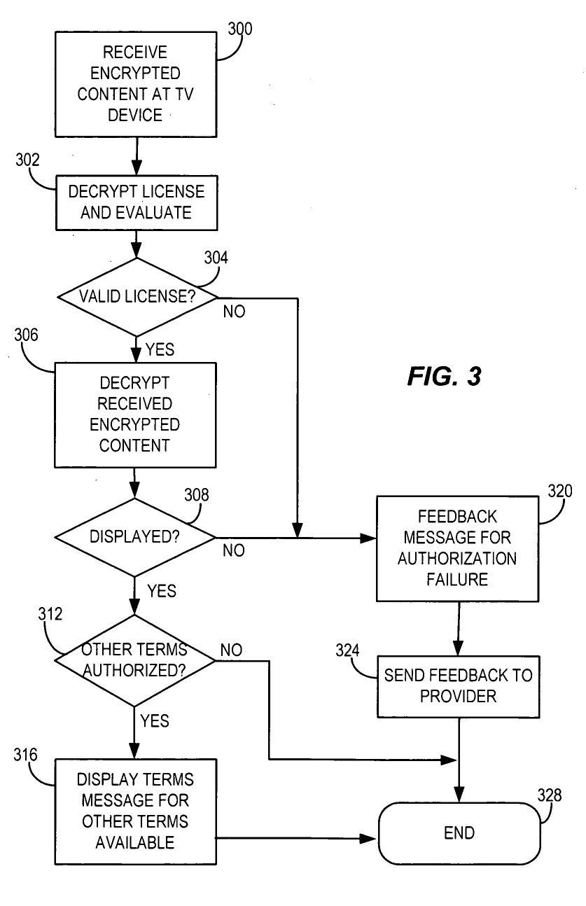

Turning now to FIG. 3, in an exemplary embodiment the very high still image content is encrypted at 300 prior to transmission. The encrypted content is then transmitted over a communication channel 104 and received at a TV device 112 for display. The service provider transmits encrypted data to the TV device that includes an encrypted license and encrypted data content. The DRM decryption and license module 200 embedded within the TV device is operative to decrypt the license 302. The DRM decryption and license module 200 then examines the license to determine the validity of the license 302 and the terms associated with the license. If the license is invalid or the terms associated with the license are invalid or incorrect 304, an error message is sent to the service provider at 320 and the image content is not displayed at 308. If the license is not valid for the particular TV the TV may display a message or other alert informing the viewer of the failure of the authorization for display for the received still image content at 320. The failure of authorization message can also be returned to the content provider as feedback at 324 to the content provider. In addition, other license terms may be evaluated at 312 and provided to the viewer for their information by displaying the additional license authorizations at 316, for example in a message on the TV display. If the license is valid and the terms are valid, the DRM decryption and license module 200 embedded within the TV device 112 decrypts the received still image content 306 and displays the decrypted image content at 308 on the TV device 112. The process ends at 328.

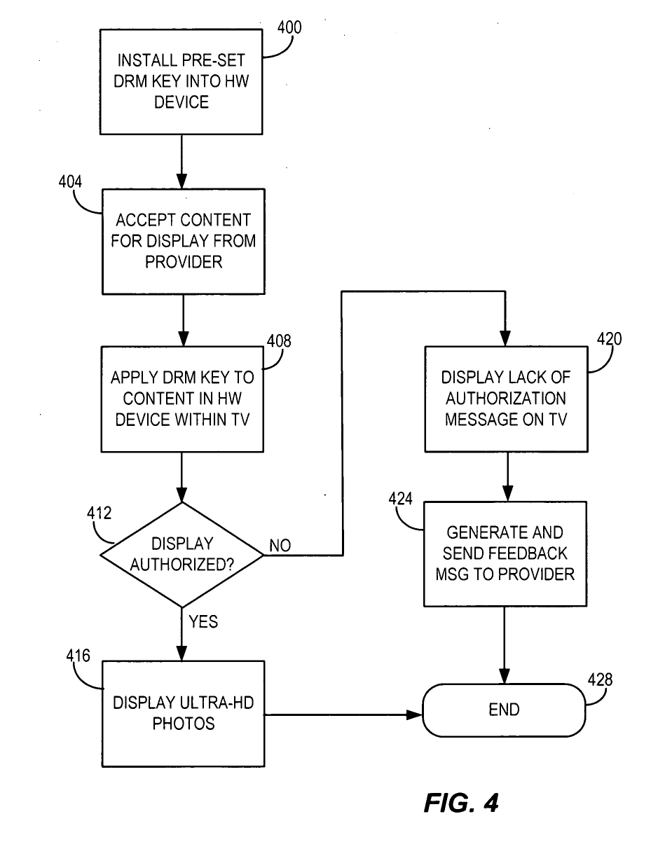

Turning now to FIG. 4, in an exemplary embodiment of a process carried out at the TV device display a pre-set and pre-selected DRM decryption key may be installed within the DRM decryption and license module at 400. This decryption key may be unique to the user, unique to the device, a general use decryption key for general use, or may be a combination of all or any of the described decryption keys. The TV device accepts the encrypted still image content from the service provider at 404 and passes the content to the DRM decryption and license module. The DRM module then applies the one or more decryption keys to the received still image content at 408 to decrypt the content and evaluate the license terms included with the received still image content. If one or more of the license terms authorizes the display for the receiving device at 412 the still image content is displayed on the TV device display at 416. However, if the licensure is not valid for the receiving device, the DRM module is operative to send a lack of authorization message to the TV device display at 420. In addition, this lack of authorization message may be sent back to the still image content provider as a feedback message at 424. The process ends at 428.

In an additional exemplary embodiment, for high resolution images for which time limited licenses are procured, the origination and management of these licenses may be invested in a 3^{rd} party service provider and may be provided to TV devices registered with the service provider. Such a service provider may provide image content to owners of the TV devices by purchasing the rights to high resolution image content, may manage licenses to such content on behalf of the image owners, or may be the owner of the image content. In each case, the 3^{rd} party service provider would be able to provide limited licenses to a library of image content from which an image license purchaser could choose. The temporary or time limited licenses may be contracted for on any of a number of contract terms, such as, by way of example, a license for a particular date and time, a license that has a renewal period, a license that has an automatic renewal option, or any other time and renewal contract terms that a viewer would prefer. The 3^{rd} party service provider would control the licensing of the image such that changing the TV device upon which the contracted image content is displayed, in essence, transfers the license to a new TV.

The display of very high definition still image content on a television display involves receiving encrypted high definition still image content at a television display device and decrypting the high definition still image content within the television display device through the use of a DRM capable decryption and licensing hardware/software module. The decryption device determines whether the television display device contains a license to display the high definition still image content and displays the high definition still image content if the license is determined to be valid. If the license is not valid, the TV displays a message indicating a lack of authorization to display the very high definition still image content.

The encrypted very high definition still images may be received from a content provider such as a broadcaster, cable service provider, photographer, art gallery, library, museum, or individual provider. The service provider sets up the licensure terms such that the license granted for display of the very high definition still image content may include a number of enforceable license conditions. The license evaluation is performed by a Digital Rights Management (DRM) algorithm installed within a hardware module embedded within the television display device.

The license validity is evaluated for a number of conditions available to the content provider. Conditions such as providing the still images on a time-limited basis, providing for a limited sharing for a pre-set number of other displays, or allowing limited printing of the still images are all evaluated and determined by the DRM module within the TV. If the receiving TV is not licensed to display the still image content received, a message may be displayed to a viewer indicating a lack of authorization to display the content. In addition, this lack of authorization message may be sent to the content or service provider as feedback on the operation of the system.

Certain embodiments may be implemented using a programmed processor executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Moreover, hardware equivalents to such a programmed processor can be used without departing from embodiments consistent with the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method for display of high definition still image content on a television display, the method comprising:
receiving encrypted high definition still image content at a television display device;
determining whether the television display device contains a license to display the high definition still image content;
decrypting the high definition still image content within the television display device if the license is determined to be valid; and
displaying the high definition still image content.

2. The method of claim 1, wherein the encrypted high definition still image is received from a content provider such as a broadcaster, cable service provider, photographer, art gallery, library, museum, or individual provider.

3. The method of claim 1, wherein the decryption is performed by separate device installed within the television display device.

4. The method of claim 1, wherein the license determining step is performed by a Digital Rights Management (DRM) algorithm installed within the television display device.

5. The method of claim 4, wherein the license validity is determined by the DRM algorithm to be time-limited; and
license timing and transfer is managed by a 3^{rd} party.

6. The method of claim 4, wherein the license validity is determined by the DRM algorithm to provide for limited sharing for a pre-set number of copies.

7. The method of claim 1, wherein the high definition still image content is provided at a minimum format of 3500 pixels by 1800 pixels.

8. The method of claim 1, wherein the displayed message indicating lack of authorization is also transmitted to the service provider.

9. The method of claim 1, wherein the TV displays a message indicating a lack of authorization if the license is not valid.

10. A system for the display of high definition still images, the system comprising:
a high definition display device;
an input channel through which high definition still image content is received by the high definition display device;
a decryption device operable to store a pre-set decryption key, decrypt incoming high definition still image content, and apply licensing parameters against the decrypted content; and
a display capable of displaying the decrypted content if the licensing is determined to be valid, otherwise displaying a lack of authorization message if the licensing is determined to be not valid.

11. The system of claim 10, wherein the display device is a high definition television.

12. The system of claim 10, wherein the decryption device is installed within, and integral to, the high definition television.

13. The system of claim 10, wherein the application of licensing parameters is performed by a DRM algorithm installed within the decryption device.

14. The system of claim 10, wherein the display is capable of displaying still image content at a minimum format of 3500 pixels by 1800 pixels.

15. The system of claim 10, wherein the high definition still image content is transmitted to the high definition television by a broadcaster, cable service provider, photographer, art gallery, library, museum, or individual provider.

16. A computer readable electronic storage medium installed within a display device for storing instructions for displaying high definition still images on a display, comprising:
receiving encrypted high definition still image content at a display device;
determining whether the display device contains a license to display the high definition still image content;
decrypting the high definition still image content within the display device if the license is determined to be valid; and
displaying the high definition still image content.

17. The computer readable storage medium of claim 16, wherein the display device is a high definition television.

18. The computer readable storage medium of claim 16, wherein the encrypted high definition still image is received from a content provider such as a broadcaster, cable service provider, photographer, art gallery, library, museum, or individual provider.

19. The computer readable storage medium of claim 16, wherein the license determining step is performed by a Digital Rights Management (DRM) algorithm installed within the television display device.

20. The computer readable storage medium of claim 16, wherein the license validity is determined by the DRM algorithm to be time-limited; and
license timing and transfer is managed by a 3^{rd} party.

21. The computer readable storage medium of claim 16, wherein the license validity is determined by the DRM algorithm to provide for limited sharing for a pre-set number of copies.

22. The computer readable storage medium of claim 16, wherein the high definition still image content is provided at a minimum format of 3500 pixels by 1800 pixels.

23. The computer readable storage medium of claim 16, wherein the displayed message indicating lack of authorization is also transmitted to the service provider.

24. The computer readable storage medium of claim 16, wherein the TV displays a message indicating a lack of authorization if the license is not valid.
